(19) United States
(12) Patent Application Publication
(10) Pub. No.: US 2009/0230925 A1
(43) Pub. Date: Sep. 17, 2009

(54) Power Saver

(76) Inventor: Nathan Nathan, Roslyn Heights, NY (US)

Correspondence Address: Nathan Nathan, 143 W29th St. 5th Floor, New York, NY, 10001, US

(21) Appl. No.: 12/075,951

(22) Filed: Mar. 14, 2008

(51) Int. Cl. H02J 7/02

(52) U.S. Cl. 320/155; 320/111

(57) ABSTRACT

A device that limits the unnecessary use of electricity and generation of unnecessary heat from adaptors used for the recharging of appliances containing rechargeable batteries.

### FIELD OF DISCLOSURE

Present disclosure relates to reducing the unnecessary use of electricity, and reducing the unnecessary heat generation from power adaptors plugged-in electric receptacles beyond the necessary requirements for charging the appliances they are intended for. The Power Saver will provide users with a simple and easy alternative to unplugging the adaptors after a preset duration of time instead of manually removing the adaptor from the outlet to disconnect the power supply.

### BACKGROUND

Many modern appliances contain rechargeable batteries that require periodic charging by using an adaptor plugged into a wall outlet such as cellular telephones, cordless vacuum cleaners, cordless drills, etc. Users of these appliances generally overuse the amount of electricity required to charge the batteries of these and similar portable appliances. Monitoring and removing the power adaptors from the electric outlet once these appliances are charged is cumbersome and not practiced by many users. For example, many users connect their phones to charge overnight, or continuously charge a cordless vacuum cleaner or cordless drill when only a few hours of charging is required to restore the charge on the appliance. Additionally, many users connect and disconnect their appliances by the cord between the appliance and adaptor, and do not unplug the adaptor from the electric outlet, continually using electricity and generating heat, a wasteful habit. In conclusion, the Power Saver device reduces the unnecessary and wasteful use of electricity, provides the user the convenience of disconnecting the power to the adaptors, and reduces pollution to the environment by saving the use of electricity and the generation of heat.

### SUMMARY

The device allows users to not have to monitor their charging portable appliances. Users may pre-set a determined length of time to charge the appliance, and frees the user from having to remove the adaptor from the electric timer. This device also overcomes the wasteful habit of users that do not unplug the adaptors from the power supply and choose to disconnect only the appliance from the adaptor.

### BRIEF DESCRIPTION OF DRAWINGS

The accompanied drawing figures, which are incorporated in and constitute a part of the description, illustrate several aspects of the Power Saver. A brief description of the figures is as follows:

FIG. 1 is a perspective view of the Power Saver according to the present disclosure with time duration tracking symbols.

FIG. 2 is the side view of the Power Saver according to the present disclosure with a tracking symbol.

FIG. 3 is the back view of the Power Saver according to the present disclosure with tracking symbols.

### DETAILED DESCRIPTION

Reference will now be made in detail to exemplary aspects of the Power Saver, which are illustrated, in the accompanying drawings. Wherever possible, the same reference will be used throughout the drawings to refer to the same or like parts.

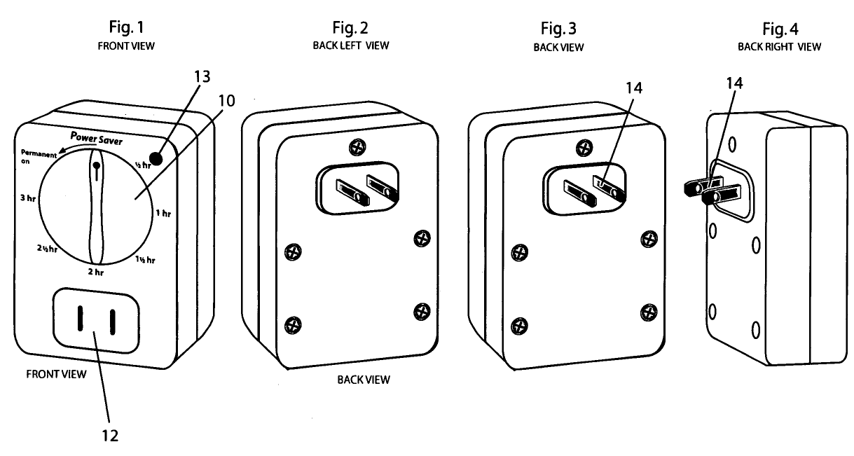

FIG. 1 illustrates the Power Saver with time tracking symbols 10 showing preset duration of time around a mechanical knob affixed, attached, printed or otherwise associated with the Power Saver. Device can work with a spring connected to a knob that is manually wound by hand by the user causing an internal mechanism to allow for the flow of electricity between the outlet and device. When the spring unwinds, it disengages the connection to the electricity and the adaptor is then disconnected from the power supply. Alternatively, an electronic circuit can be used instead of a spring-mechanical timer, and the savings in power would be the difference of the electric usage of the adaptor less the amount of electric use by this circuit.

FIG. 1 illustrates the Power Saver with the tracking symbol 11 and 12 depicting possible locations for single or multiple outlets where one or more adaptors are plugged to connect to the power supply when the spring-operated mechanism is wound or alternatively the electronic circuit allows for the flow of electricity to be between the outlet and the outlets on the device. Adaptors such as a cellular phone, cordless vacuum cleaner, cordless drill, etc., can be plugged into the Power Saver with tracking numbers 11 and (or) 12.

FIG. 1 illustrates the Power Saver with the tracking symbol 13, depicting a light bulb or Light Emitting Diode or the like that can be included in the device to turn on when the electric power is flowing to the outlet(s) 12 and 11.

FIG. 2 illustrates the Power Saver with the tracking symbol 14 for the possible location of prongs of the actual Power Saver device that are plugged in the wall outlet to connect to the electricity and tracking symbol 11 depicting possible location for an outlet where one adaptor is plugged to connect to the power supply when the spring-operated mechanism is wound and permits this or when the alternative electronic circuit allows for.

FIG. 3 illustrates the Power Saver in back view, tracking symbol 14 for the possible location of prongs of the Power Saver device that are plugged in the wall outlet to connect to electricity and tracking symbol 11 depicting possible location for a single outlet where one adaptor can be plugged to connect to the power supply when the spring-operated mechanism is wound and permits this or when the alternative electronic circuit allows for.

FIG. 4 illustrates the Power Saver in the back right view, tracking symbol 14 for the possible location of prongs of the actual Power Saver device that are plugged in the wall outlet to connect to electricity.

What is claimed is:

1. A device that encourages users not to waste electricity by setting a predetermined time to disconnect the power from adaptors used to charge appliances containing rechargeable batteries.

2. The method of claim 1, wherein the Power Saver has a spring operated knob used to mechanically unwind and disconnect the electric power supply from the electricity.

3. The method of claim 2, wherein the spring-operated knob has timed interval markings to accommodate the pre-set length of time for charging time for an assortment of portable appliances.

4. The method of claim 1, wherein the Power Saver has one or more outlets and where one or more adaptors may be plugged-in to connect to the electricity, and the adaptor or other device plugged into the Power Saver has a preset duration of time where the flow of electricity is useful to its operation.

5. The method of claim 1, wherein the Power Saver has a light bulb or Light Emitting Diode that visibly indicates to the user when the flow of electricity to the appliance or device is occurring.

6. The method of claim 1, wherein alternatively the Power Saver has an electric circuit that controls the flow of electricity between the supply and the outlets on the device to cut off at a preset time set by the circuit instead of a spring loaded switch mechanism.
